(19) United States
(12) Patent Application Publication
(10) Pub. No.: US 2009/0095230 A1
(43) Pub. Date: Apr. 16, 2009

(54) HANGING BIRD TOYS

(75) Inventor: Jonathan Willinger, Tenafly, NJ (US)

Correspondence Address: KATTEN MUCHIN ROSENMAN LLP, 575 MADISON AVENUE, NEW YORK, NY, 10022-2585, US

(73) Assignee: J.W. PET COMPANY, INC., Teterboro, NJ (US)

(21) Appl. No.: 12/335,089

(22) Filed: Dec. 15, 2008

Related U.S. Application Data
(62) Division of application No. 11/151,382, filed on Jun. 13, 2005, now abandoned.

(51) Int. Cl. A01K 29/00

(52) U.S. Cl. 119/708

(57) ABSTRACT

A hanging bird toy includes a link having two widened portions and a narrow portion between the widened portions. A central component is disposed in the link in the narrow portion; and an insert is disposed in one of the widened portions.

### CROSS-REFERENCE TO RELATED APPLICATIONS

This application is divisional application of and claims priority to U.S. Ser. No. 11/151,382, filed on Jun. 13, 2005, which is hereby incorporated by reference in its entirety for all purposes.

### BACKGROUND OF THE INVENTION

1. Field of the Invention

The invention relates to a modular bird toy assembly. More particularly, the invention relates to bird toys, which can be assembled in a customized manner by the bird owner.

2. Background

In natural settings, birds spend their time engaged in interesting and stimulating activities. Much of that time is spent investigating oddities that the birds observe in their environment.

While in a natural habitat birds are free to choose different locations, domestic birds have much more limited environment in which to seek stimulation. Many bird owners attempt to alleviate this condition and do not keep their birds in the cage at all times. In fact, many birds are allowed free movement within their owner's home, and return to the cage only at night. Even so, a bird with free reign that lacks intellectual stimulation can be quite destructive, typically to home furnishings. Based on extensive tests, animal psychologists have not unsurprisingly concluded that birds should have a great range of intellectual stimulation to enjoy their life in captivity.

Accordingly, there is a need for bird toys having a modular structure that can be easily reassembled to assume different configurations.

### SUMMARY OF THE INVENTION

In accordance with one aspect of the invention, a bird toy is configured as a plurality of components, which can be selectively assembled together to have various shapes and forms. Individual components of the toy have respective means for attaching that can be easily manipulated by the bird owner for modifying the configuration of the toy.

In accordance with a further aspect of the invention, a kit comprising numerous detached components is provided. Following the accompanying instructions or his/her own design, the bird owner may assemble various toys by selectively coupling their individual components to one another.

Toys may be mounted directly to any support within a cage or anywhere within a confined environment. Preferably, however, the inventive toys are provided in combination with a cage, which, when the toys are placed inside it, represents an entertainment center for the birds.

These and other features and aspects of the present invention will be better understood with reference to the detailed description accompanied by the following drawings.

### BRIEF DESCRIPTION OF THE DRAWINGS

FIG. 1A illustrates a first embodiment of the inventive toy including a plurality of removably attachable links;

FIG. 1A illustrates an attachment assembly for assembling individual links of the first embodiment of the inventive toy;

FIG. 2A illustrates the inventive toy assembled in accordance with a second embodiment of the invention;

FIG. 2B illustrates an exploded view of the toy of FIG. 2A;

FIG. 3A illustrates a third embodiment of the inventive toy including a plurality of detachable links;

FIG. 3B illustrates an attachment assembly for assembling individual links of the inventive toy of FIG. 3A;

FIG. 4A illustrates a fourth embodiment of the inventive toy;

FIG. 4B illustrates an individual link of the toy of FIG. 4A;

FIG. 5A illustrates a fifth embodiment of the inventive toy;

FIG. 5B illustrates a detail of the toy illustrated in FIG. 5A;

FIG. 6A illustrates a sixth embodiment of the inventive toy;

FIG. 6B illustrates one configuration of an attachment assembly utilized in the embodiment of FIG. 6A;

FIG. 6C illustrates another configuration of an attachment assembly of the embodiment shown in FIG. 6A;

FIG. 7A illustrates a seventh embodiment of the inventive toy;

FIG. 7B illustrates cross section of a link utilized in the embodiment of FIG. 7A;

FIG. 7C illustrates a further type of attachment assembly of FIG. 7A;

FIG. 8A illustrates an eighth embodiment of the assembled inventive toy; and

FIG. 8B illustrates an exploded view of the toy illustrated in FIG. 8A.

### DETAILED DESCRIPTION

Reference will now be made in detail to several embodiments of the invention that are illustrated in the accompanying drawings. The drawings are in simplified form and are not to precise scale. For purposes of convenience and clarity only, directional terms, such as left, right, inside, outside, top, bottom, left, above, below and beneath may be used with respect to the drawings. These and similar directional terms should not be construed to limit the scope of the invention in any manner. The words “connect,” “couple,” “attach” and similar terms with their inflectional morphemes do not necessarily denote direct and immediate connections, but also include connections through mediate elements.

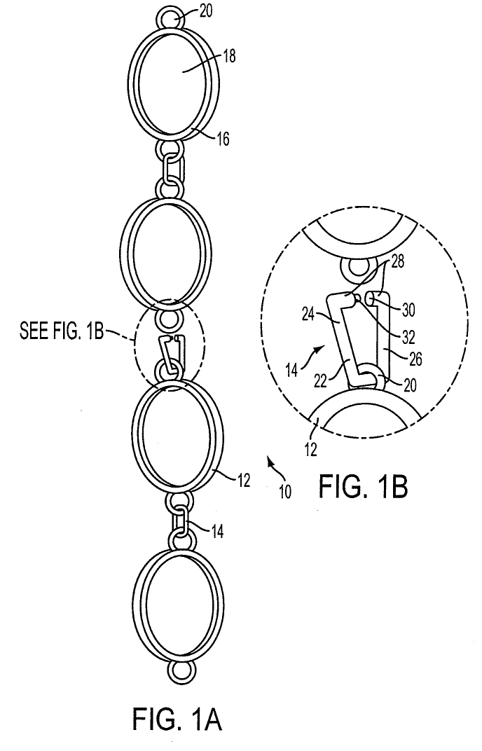

FIGS. 1A and 1B illustrate a chain-like toy 10 including a plurality of links 12 removably coupled to one another by respective connectors 14. Shapes and dimensions of toy 10 can be limitlessly varied as long as individual links 12 can be detached from one another for further reattachment. Similarly, the number and size of individual links 12 is not fixed.

A preferred modification of toy 10 may include annular links 12. A body of each link 12 can be provided with a continuous periphery 16. Preferably, materials used for manufacturing links 12 include polymeric materials, such as a variety of plastics and rubber. Optionally, the links may be made from metal and even wood, if desired.

The space delimited by periphery 16 may be filled with an insert 18. The insert has an outer edge conforming the inner surface of the body of the link, which may be formed with an annular groove or a ledge (not shown) receiving the edge of the insert. Coupling between the insert and the link's body may be realized by various methods including, but not limited to, gluing and press fitting.

One of possible modifications of insert 18 may comprise a mirror. Alternatively, a polished metal plate can be used to produce the mirror effect. Furthermore, inserts 18 may be made of clear or opaque colored material

In a further modification of link 12, periphery 16 of the body may not be continuous, but include a plurality of detachable segments that, once coupled together, define a final shape. As mentioned above a variety of shapes are contemplated within the scope of the invention. While a generally circular body is illustrated in FIG. 1, it can have a polygonal or any other regular or irregular cross-section.

The links 12 are connected to one another by respective connectors 14, each of which, as shown in FIG. 1B, comprises an eyelet 20, which is formed on the links, and a hook component 22. In accordance with the main concept, hook component 22 is configured to engage eyelets 20 in a manner allowing the bird's owner to decoupled links 12, if a new configuration of toy 10 is desired. The eyelets 20 may be provided on the outer periphery of each link in any possible combination including a single or multiple eyelets. A relative angular distance between multiple eyelets formed on each link is not fixed and can vary. Provided only as an example, FIG. 1A illustrates two eyelets 12 spaced diametrically opposite to one another.

The hook component 22 may include a generally U-shaped body dimensioned so that it can be relatively easily pushed through and pivot in eyelet 20, which is formed on link 12, while the bird owner engages the other link with free ends of hook 22.

As illustrated in FIG. 1, hook 22 has a pair of sides 24 and 26 bridged by the bottom portion of the hook and having respective free ends 28. Preferably, free ends 28 are angled inwards to face one another. Formed with a snap connection, which may include a pin 32 and a cavity 30 located on opposing free ends 28, respectively, connector 14 can be easily manipulated by the bird owner. The cavity and pin are dimensioned to tightly fit one another upon applying an external force. However, the configuration of the snap connection allows the bird owner to not use excessive forces, when it is desired to unfasten connector 14.

The configuration of hook 22 and eyelet 20 may be subject to numerous modifications. For example, the position and configuration of the illustrated eyelet 20 and connector 22 can be reversed.

The chain of FIG. 1A may be suspended on any support within a cage or anywhere in a room or house. The toy 10 can be modified during its use by, for example, connecting the opposite ends of the chain together and, thus, forming an annular body, or by adding new links that may be similar to links 12 or have different shape and size.

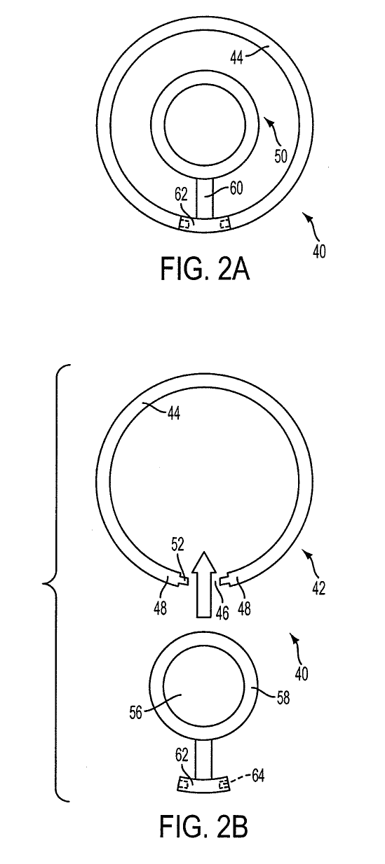

The inventive toy 40 illustrated in FIGS. 2A and 2B has a slightly different configuration of links 42, only one of which is shown, although a plurality may be joined in succession to create a chain. A body 44 of the link is recessed to form an opening 46, which is defined between two free ends 48 and dimensioned to provide a passage for an insert 50. Each of opposite free ends 48 may have a pointed end or pin 52 having a reduced diameter, as compared to the rest of body 44 of the link. When insert 50, which has, for example, an mirror central portion 56 supported by a frame 58, is inserted into the link, pins 52 engage corresponding recesses 64 formed on a foot portion 62 of the insert.

In the modification of FIGS. 2A and 28, insert 50 is also provided with a leg 60 bridging the insert's frame 58 and foot 62. The leg may be differently dimensioned, but preferably has a length allowing insert 50 to occupy a substantially central location within the link. The foot 62 is shaped to complement the contour of link frame 44. As a consequence, as shown in FIG. 2A, the assembled link has a smooth outer and inner periphery.

The mirror portion 56 of insert 50 can be differently shaped and dimensioned, but must fit within the space delimited by the inner peripheral surface of the link's frame 44. A relative position of pins 52 of the link and recesses 64 of the insert's foot can be reversed so that the recesses are provided within free ends 48 of the link, while the pins are formed on the ends of the of the foot of the insert.

To assemble toy 40, opposite free ends 48 of the link are tensioned away from one another at a distance sufficient for the foot to fill the gap between ends 48. Due to elasticity of the material of the link or in response to an external force, once a tension force is removed, ends 48 tend to move towards one another with pins 52 penetrating respective recesses 64.

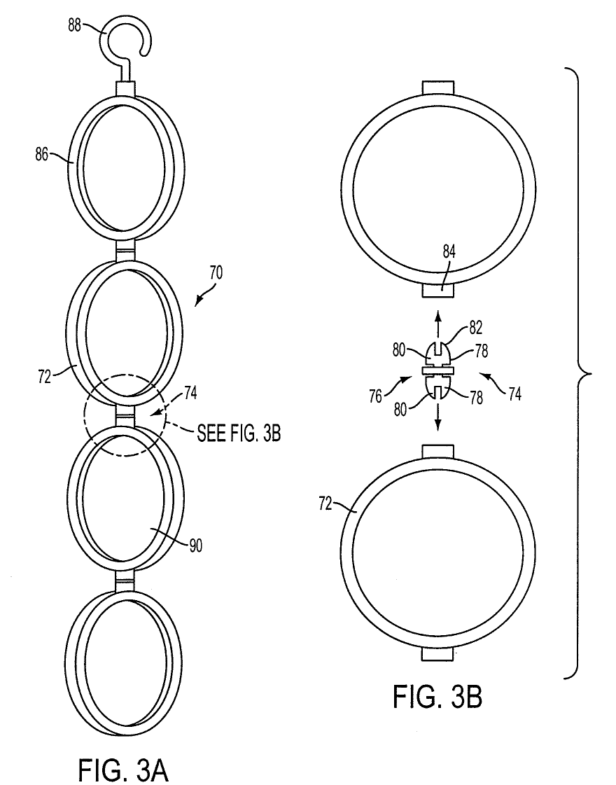

FIGS. 3A and 38 illustrate a toy 70 that, like toy 10 of FIGS. 1A and 1B, may be configured with multiple detachable links or single link 72. An attachment assembly 74, better illustrated in FIG. 3B, includes a body 76 having opposite fork-shaped ends. Each of the fork-shaped ends has two arms 78 and 80 defining a recess 82 therebetween. When link 72 is brought into engagement with connection assembly 74, a projection 84, which is formed on the outer periphery of the link, is pushed between arms 78 and 80. As a result, the arms are slightly pulled away, but frictionally engage and press upon inserted projection 84. When the links are engaged, attachment assembly 74 assumes a substantially rectangular shape, as shown in FIG. 3A. At least one of end links 86 is formed with a hook 88 configured to engage a suitable support. Preferably, each of the links supports a mirror 90.

The sides of arms 78 and 80 opposing one another may be provided with a snap connection, as explained in reference to FIGS. 1A and 1B, and engage protrusion 84 formed on the links, which, in accordance with this configuration, may be configured as a bracket.

In a further embodiment, protrusion 84 is a collar disposed in a raised position from a peripheral body portion of link 72. Arms 78 and 80 are snap fit into protrusion 84 and may be retained by a further stepped portion in the collar to secure attachment assembly 74 to link 72. A similar protrusion 84 may be disposed in a subsequent link so at join links together. Preferably, attachment assembly 74 is so configured as to permit the independent movement of links 72 as shown in FIG. 3A.

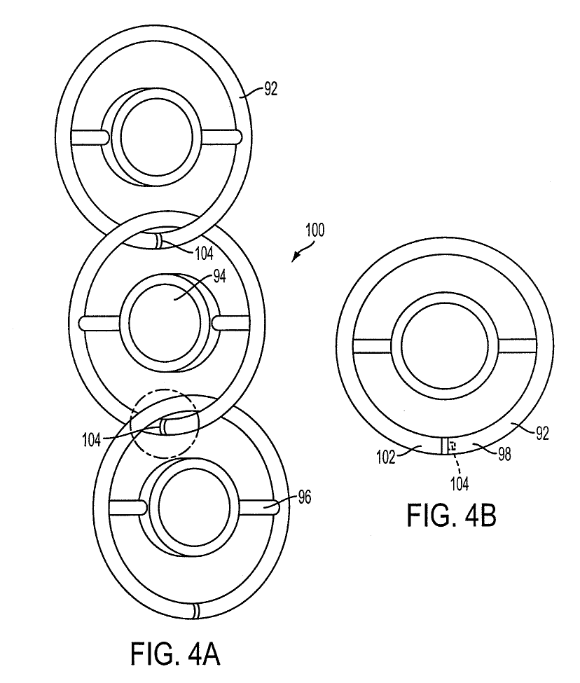

FIGS. 4A and 4B illustrate a further chain-like configuration of inventive toy 100. Each of multiple links 92 has a discontinuous periphery characterized by a pair of opposite free ends 98 and 102. Formed with a snap connection 104, which may include a pin and a cavity (not shown), the free ends are pressed against one another so that the pin is frictionally engaged within the recess. To assemble toy 100, the bird owner tensions the opposite free ends away from one another so as to form a passage for an adjacent link. After the links are engaged, a tension force is removed, and ends 98 and 102 are pushed towards and engage one another.

An insert 94 includes an inner portion, preferably comprising a mirror, which is centered within link 16 on at least one legs 96. The legs may be detachably coupled to the inner surface of the link's periphery, as will be explained herein below, or permanently fixed to the link.

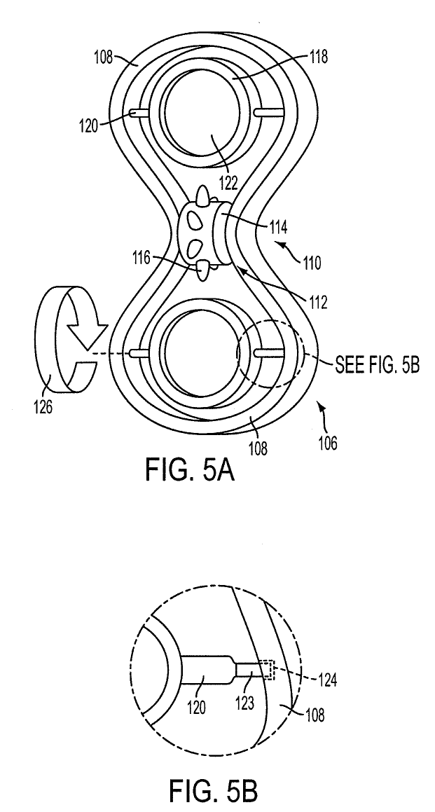

FIGS. 5A and 5B illustrate another modification of inventive toy 110 that can comprise a single link 106 or multiple links. Having generally an hour-glass shape, link 106 may be flexible and includes opposite end portions 108 each having a substantially frustoconical cross-section. Narrowing towards the center of the link, end portions 108 form a gap 112 bridged by a central component 114. Advantageously, this shape allows a user to press the end portion and remove insert 118 (further described herein). The latter may have numerous shapes and configurations, but, as shown in FIG. 5A, comprises generally an annular body with a plurality of uniformly or non-uniformly spaced and configured spikes or protrusions 116.

An insert 118 is mounted within each end portion 108 and has a central mirror portion 122, which may be independently movable relative to toy 110, coupled to the inner periphery of the end portions by a plurality of legs 120. Referring to FIG. 5B, each leg 120 may be formed with a neck 123 having its free end 124 threaded. A location of the end portion 108, which is intended to receive threaded free ends 124 of the leg, is formed with a threaded opening or cavity from which insert 118 may be removable and interchangeable.

To assemble toy 110, the bird owner threads the legs into respective openings, as diagrammatically illustrated by an arrow 126. Alternatively, free ends 124 of legs 120 may be dimensioned to tightly fit in the respective openings. In this modification, initially, the bird owner inserts one of the opposite legs 120 of insert 118 into a respective opening, and then forces the free end of the opposite leg into the other opening. The same attachment assembly can be provided between central component 114, which may be an attractant that is independently movable with respect to toy 110 and that may offer a different tactile sensation, and the central region of toy 110.

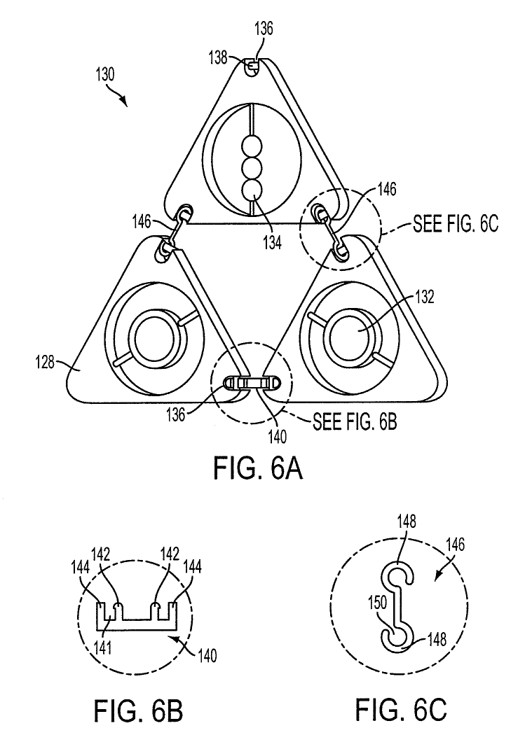

FIGS. 6A-6C show a further modification of inventive toy 130 comprising three triangular links 128. Each of the links includes a central opening filled with an insert. Inserts may be differently configured. For example, one of the links may have an insert 132 configured with a mirror central portion, as explained above and which may be independently movable relative to toy 130. Other links 128 may comprise other toys such as abacus style items 134, such as a rod and movable beads disposed on the rod, which may be independently movable relative to toy 130 and which are coupled to the inner periphery of the link.

At least some of the comers of each link have respective recesses 136, each of which may be provided with a pin 138 extending over the entire width of the recess. To couple the links, various modifications of an attachment assembly may be employed. As shown in FIG. 6B, opposite ends of a bracket 140 each are formed with a pair of teeth 142 and 144 having free angled ends, which extend towards one another to form a relatively narrow passage 141 into the inner space between the teeth of each pair. The passage 141 is so dimensioned, that the bird owner has to apply a force in order to push pin 138 of the link between the teeth. Upon passing the passage, the pin is prevented from inadvertently slipping out of engagement, unless, the owner applies the force again.

A different configuration of attachment assembly is illustrated in FIG. 6C and includes a bracket having two opposite hook-shaped end portions 148. Similar to passage 141 of FIG. 6B, the end portion of each hook forms a passage 150 dimensioned so that the bird owner has to apply a force in order to push pin 138 into the inner space of each end hook portion.

As in any of the above-discussed embodiments, once the links are coupled, they are free to move relative to one another due to specifically selected dimensions of the attachment assembly provided on the links.

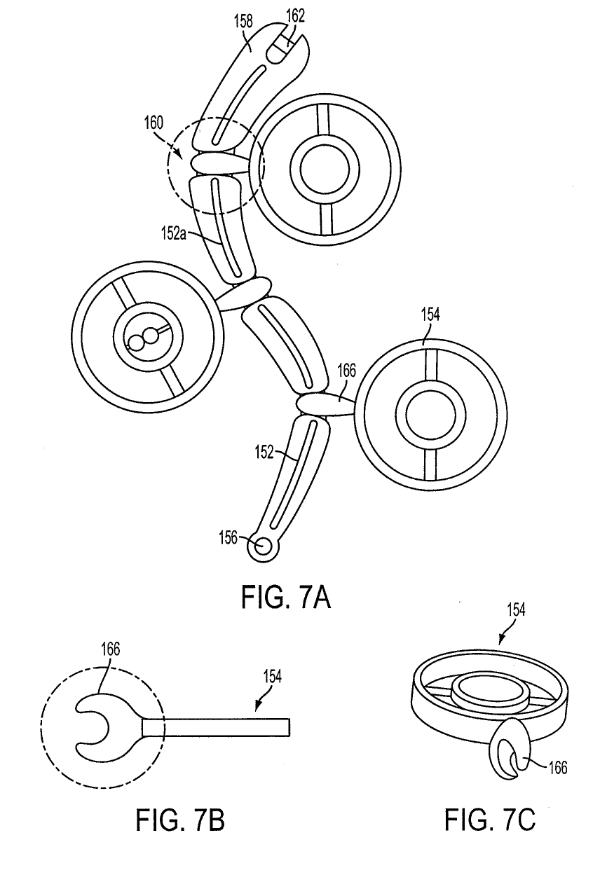

FIGS. 7A-7C illustrate a wave-shaped toy 160 configured with a spine 152 and a plurality of links 154. A wave body of the toy is defined by the spine 152 having elongated spacer portions 152a and connector portions 152b. Elongated spacer portions 152a may have a cylindrically shaped cross-section, conically-shaped cross section and/or many others. Differently shaped links 154 may be connected at connector portions 152b and carry mirrors or other inserts which may be rotatable inside the link. Other links each have one of opposite ends 158 recessed and provided with a pin 162 for mounting of other toys. One of the end links 154 has a hook formation 166 configured to mount link 154 to connector portion 152b, as illustrated in cross-section of FIG. 7B and in isometric view FIG. 7C.

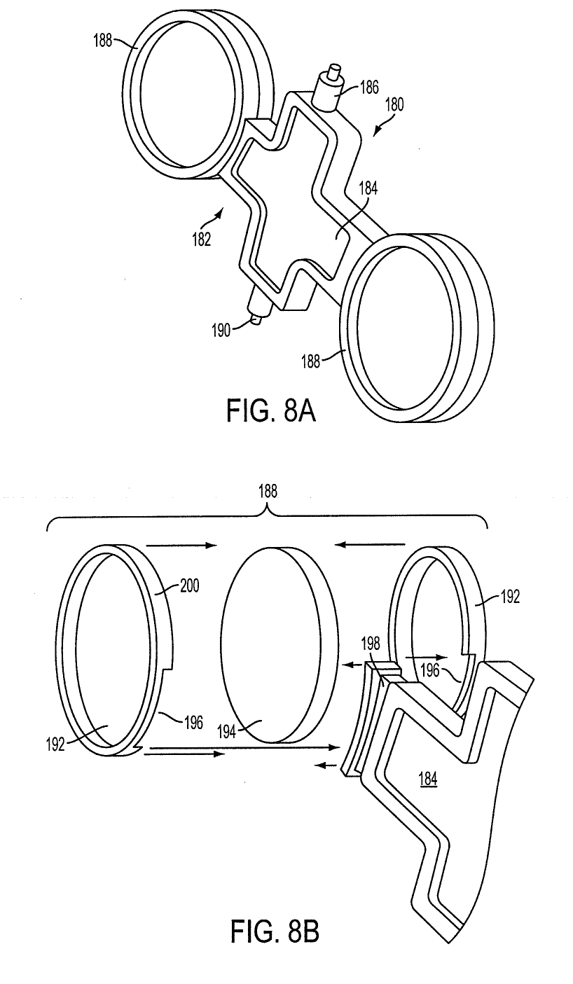

Referring to FIGS. 8A and 8B, one of multiple links 182 of a toy 180 has a central cross-shaped body 184, which is configured to receive multiple end portions 188. Shown as rings, end portions 188 may have a variety of configurations and be either fixed to the central body or detachably coupled thereto.

One of possible configurations of an attachment assembly may comprise a leg 186 formed with a narrow end or pin 190 that can tightly fit an opening of the end portion. A further modification of the attachment assembly may include the pin 190 provided with a male thread engaging a female thread of the opening of the end section (not shown). The pin 190 may be formed on end portion 188. In this case, the opening is formed within central body 184.

End portions 188 may have a multi-component structure illustrated in FIG. 8B and including two end sections 192, which are shaped and dimensioned to sandwich a middle section 194. Each end section 192 has a slightly larger inner diameter than the outer diameter of middle section 194 and is provided with a peripheral recess 196, which is shaped and dimensioned to tightly engage a portion of end flange 198 extending from central body 184.

To assemble the end portion 188 and couple it to end flange 198, the bird owner, first, mounts one of the end sections 192 to one side of the end flange by applying a pushing force to end section 192. Then, middle section 194 is placed within the mounted end section 192. Finally, other end section 192 is mounted to the opposite side of flange 198 so as to enclose middle section 194. A peripheral collar 200 of each end section 192 is dimensioned to cover approximately half a width of flange 198 of central body 184. Sections 192 and 194 of end portion 188 may have a uniform width and an outer diameter. In this case, end sections 192 abut opposite surfaces of central section 194 upon mounting to flange 198 of the central body. The overall thickness of the end portions may be slightly greater than the thickness of the central body.

Typically the toys are hung from a support, such as the bird cage ceiling, using a hook connected to a suitable location on the toy and may be finished by attaching a noisemaker, such as a bell, or other attractant at an end of the toy or chain of toys opposite the hook.

This document describes the inventive bird toys and methods for assembling these toys. Neither the specific embodiments of the invention as a whole, nor those of its features limit the general principles underlying the invention. In particular, the invention is not limited to any individual embodiment. The toys illustrated in different figures can be easily combined with one another. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention.

What is claimed is:

1. A hanging bird toy comprising:
a link comprising two widened portions and a narrow portion between the widened portions;
a central component disposed in the link in the narrow portion; and
a first insert disposed in one of the widened portions.

2. The hanging bird toy of claim 1, wherein the link is flexible.

3. The hanging bird toy of claim 1, wherein the first insert comprises a mirror.

4. The hanging bird toy of claim 1, wherein the first insert is rotatable relative to the link.

5. The hanging bird toy of claim 1, wherein the first insert comprises an axle receivable in the link.

6. The hanging bird toy of claim 1 further comprising a second insert disposed in the other of the widened portions.

7. The hanging bird toy of claim 1, wherein the link comprises an hour-glass shape.

8. The hanging bird toy of claim 1 further comprising a second link.

9. The hanging bird toy of claim 1, wherein the central component is rotatable relative to the link.

10. A hanging bird toy comprising:
an hour-glass shaped link,
an insert held in the link and rotatable relative to the link.

11. The hanging bird toy of claim 10, wherein the link has an endless shape.

12. The hanging bird toy of claim 10, wherein the insert comprises a mirror.

13. The hanging bird toy of claim 10 further comprising a second insert.

14. The hanging bird toy of claim 10 further comprising a component disposed in a central portion of the link.

15. The hanging bird toy of claim 10 further comprising a second link.

16. The hanging bird toy of claim 14 wherein the component comprises protrusions.

17. A hanging bird toy comprising:
an hour-glass shaped link,
a plurality of spaced-apart inserts, and
a component disposed in a central portion of the link.

18. The hanging bird toy of claim 17, wherein at least one insert is rotatable relative to the link.

19. The hanging bird toy of claim 17, wherein at least the component is rotatable relative to one of the link and one of the inserts.

20. The hanging bird toy of claim 17 further comprising a second link.
